(19) United States
(12) Patent Application Publication
(10) Pub. No.: US 2009/0282332 A1
(43) Pub. Date: Nov. 12, 2009

(54) APPARATUS, METHOD AND COMPUTER PROGRAM PRODUCT FOR SELECTING MULTIPLE ITEMS USING MULTI-TOUCH

(75) Inventor: Ofri Olavi Porat, Tampere (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 12/118,975

(22) Filed: May 12, 2008

(51) Int. Cl. G06F 3/01

(52) U.S. Cl. 715/702

(57) ABSTRACT

An apparatus, method and computer program product are provided for selecting multiple items on a touchscreen using multi-touch. In order to select an item and, by extension, an underlying object associated with the item, a user may touch the touchscreen proximate the area at which the item is displayed using multiple fingers, or other selection devices. In response to detecting that the user has touched the touchscreen using multiple fingers, or other selection devices, the electronic device may modify the graphical item to indicate that it is selected and identify the underlying object as selected. After selecting two or more graphical items and corresponding objects in this manner, the user may enter a command to be taken with respect to the selected graphical items and/or objects. In response, the electronic device may cause the action associated with the command to be performed with respect to the selected items and/or objects.

### FIELD

Embodiments of the invention relate, generally, to touch sensitive input devices and in particular, to an improved technique for selecting multiple items displayed on a touch sensitive input device using multi-touch.

### BACKGROUND

In many instances a user of an electronic device (e.g., cellular telephone, personal digital assistant (PDA), laptop, personal computer, etc.) may desire to take some action with respect to more than one item displayed on the electronic device display screen and/or with respect to the corresponding objects associated with those items. The objects may include, for example, audio, video, text or multimedia files, applications, emails, Short Message Service (SMS) or Multimedia Message Service (MMS) messages, and/or the like. For example, a user may wish to delete multiple emails, or other similar messages, from his or her inbox, wherein each email has a corresponding graphical item displayed on the electronic device display screen. As another example, a user may desire to move the graphical items associated with a group of applications from one location on the electronic device display screen to another location, wherein the movement may not necessarily affect the underlying applications.

Currently, for many devices having a touch sensitive input device or touchscreen, in order to select multiple items displayed on the touchscreen at one time, the user may have to first place the device in “selection” or “mark” mode prior to selecting or marking the desired items. This can involve several steps including, for example, opening an options menu, activating the selection or mark mode, closing the menu, individually selecting each item, inputting the command to be taken with respect to the selected items, and, finally, re-opening the options menu in order to de-activate the selection or mark mode. This can be time consuming and cumbersome. As an alternative, some systems may allow you to use two fingers to designate an area on a touchscreen, wherein items within the area are selected and those outside are not. This technique may be difficult, however, depending upon the location and manner in which the items are displayed. For example, if the items are not displayed within close proximity to one another and/or there are additional items that the user does not wish to select lying in between the desired items, it may be difficult for the user to draw around the desired items.

A need, therefore, exists for a way to enable a user to more quickly and easily select multiple items on a touch sensitive input device or touchscreen.

### BRIEF SUMMARY

In general, embodiments of the present invention provide an improvement by, among other things, providing an improved technique for selecting multiple items displayed on a touch sensitive input device. In particular, according to one embodiment in order to select multiple items and, therefore, the underlying objects associated with those items (e.g., audio, video, text or multimedia file, application, email, SMS or MMS message, etc.), a user may touch the touchscreen proximate the area at which each item is displayed using more than one finger, or other selection device (e.g., pen, stylus, etc.). In response to detecting that the user has touched the touchscreen using multiple fingers, or other selection devices, the electronic device (e.g., cellular telephone, personal digital assistant (PDA), laptop, personal computer (PC), etc.) may modify the graphical item to indicate that it is selected (e.g., change the color of the graphical item, add a mark, etc.), and identify the underlying object as selected (e.g., by adding a unique identifier associated with the underlying object to a list of objects that have been selected, modifying a parameter associated with the object, etc.).

At some point thereafter (i.e., after all desired items have been selected), the user may enter a command to be taken in association with the selected graphical items and/or objects. The command may include any action or function that could be taken with respect to the items and/or their underlying objects including, for example, deleting, saving or editing the objects, altering the location of the graphical items, and/or the like. In response to receiving the command, the electronic device of one embodiment may then cause the action associated with the command to be taken with respect to the selected items and/or objects.

In accordance with one aspect, an apparatus is provided for selecting multiple items displayed on a touchscreen using multi-touch. In one embodiment, the apparatus may include a processor that is configured to: (1) detect two or more tactile inputs on a touch sensitive input device proximate a location at which each of two or more graphical items is displayed, wherein the two or more graphical items are associated with a corresponding two or more objects; (2) identify the two or more graphical items and the corresponding two or more objects as selected; (3) receive a command; and (4) cause a function associated with the received command to be activated with respect to the two or more graphical items identified as selected, the two or more objects identified as selected, or the two or more graphical items and the two or more objects identified as selected.

In accordance with another aspect, a method is provided for selecting multiple items displayed on a touchscreen using multi-touch. In one embodiment, the method may include: (1) detecting two or more tactile inputs on a touch sensitive input device proximate a location at which each of two or more graphical items is displayed, wherein the two or more graphical items are associated with a corresponding two or more objects; (2) identifying the two or more graphical items and the corresponding two or more objects as selected; (3) receiving a command; and (4) causing a function associated with the received command to be activated with respect to the two or more graphical items identified as selected, the two or more objects identified as selected, or the two or more graphical items and the two or more objects identified as selected.

According to yet another aspect, a computer program product is provided for selecting multiple items displayed on a touchscreen using multi-touch. The computer program product contains at least one computer-readable storage medium having computer-readable program code portions stored therein. The computer-readable program code portions of one embodiment may include: (1) a first executable portion for detecting two or more tactile inputs on a touch sensitive input device proximate a location at which each of two or more graphical items is displayed, wherein the two or more graphical items are associated with a corresponding two or more objects; (2) a second executable portion for identifying the two or more graphical items and the corresponding two or more objects as selected; (3) a third executable portion for receiving a command; and (4) a fourth executable portion for causing a function associated with the received command to be activated with respect to the two or more graphical items identified as selected, the two or more objects identified as selected, or the two or more graphical items and the two or more objects identified as selected.

According to another aspect, an apparatus is provided for selecting multiple items displayed on a touchscreen using multi-touch. In one embodiment, the apparatus may include: (1) means for detecting two or more tactile inputs on a touch sensitive input device proximate a location at which each of two or more graphical items is displayed, wherein the two or more graphical items are associated with a corresponding two or more objects; (2) means for identifying the two or more graphical items and the corresponding two or more objects as selected; (3) means for receiving a command; and (4) means for causing a function associated with the received command to be activated with respect to the two or more graphical items identified as selected, the two or more objects identified as selected, or the two or more graphical items and the two or more objects identified as selected.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of an entity capable of operating as an electronic device configured to provide the multi-touch selection technique in accordance with embodiments of the present invention;

FIG. 2 is a schematic block diagram of a mobile station capable of operating in accordance with an embodiment of the present invention;

FIG. 3 is a flow chart illustrating the operations that may be performed in order to select multiple items using multi-touch in accordance with embodiments of the present invention; and

FIGS. 4A-4D illustrate the process of selecting multiple items using multi-touch in accordance with embodiments of the present invention.

### DETAILED DESCRIPTION

Embodiments of the present invention now will be described more fully hereinafter with reference to the accompanying drawings, in which some, but not all embodiments of the inventions are shown. Indeed, embodiments of the invention may be embodied in many different forms and should not be construed as limited to the embodiments set forth herein; rather, these embodiments are provided so that this disclosure will satisfy applicable legal requirements. Like numbers refer to like elements throughout.

### Overview:

In general, embodiments of the present invention provide an apparatus, method and computer program product for selecting multiple items displayed on an electronic device (e.g., cellular telephone, personal digital assistant (PDA), laptop, personal computer (PC), etc.) touchscreen or touch display using multi-touch. In particular, according to one embodiment, in order to select a graphical item and, by extension, an underlying object associated with the item (e.g., text, audio, video or multimedia file, application, email, SMS or MMS message, etc.), a user may touch the touchscreen proximate the area at which the graphical item is displayed using more than one finger, or other selection device (e.g., pen, stylus, etc.). In response to detecting the multiple tactile inputs associated with the user touching the touchscreen, the electronic device may modify the graphical item to indicate that it is selected, as well as identify the underlying object as selected. For example, the electronic device may change the color of or add a mark to the graphical item, add a unique identifier associated with the underlying object to a list of objects that have been selected, toggle a selected/unselected parameter associated with the object, and/or the like.

The user may repeat this process until each of the desired items and corresponding objects have been selected. In one embodiment, if the graphical items are located adjacent one another on the electronic device touchscreen, the user may drag his or her fingers (or other selection devices) from one graphical item to the other in order to select both items. In other words, the tactile inputs detected in association with each graphical item and corresponding object may be continuous.

If the user decides that he or she does not want to select one of the previously selected items (e.g., he or she decided not to take a desired action with respect to a previously selected item and/or underlying object), according to one embodiment, the user may re-touch the item using multiple fingers, or other selection devices. In response, the graphical item may be restored to its original format, and the object may be identified, again, as unselected (e.g., by removing the unique identifier from the list of selected objects, toggling the parameter, etc.).

Once the user has selected all of the desired items and underlying objects, he or she may then input a command to be taken with respect to the selected items and/or objects. As one of ordinary skill in the art will recognize, the command may include any action or function that could be taken with respect to any graphical item and/or objects including, for example, saving, deleting and/or editing the graphical item and/or object. Upon receipt of the command, the electronic device of one embodiment may cause the action or function associated with the received command to be taken with respect to the selected items and/or objects (e.g., delete all messages selected).

Based on the foregoing, embodiments of the present invention may enable a user to take some action with respect to multiple graphical items and/or the corresponding objects without having to take the action individually with respect to each item and/or object, and without having to go through the steps of placing the electronic device in a special “selection” or “mark” mode.

### Electronic Device:

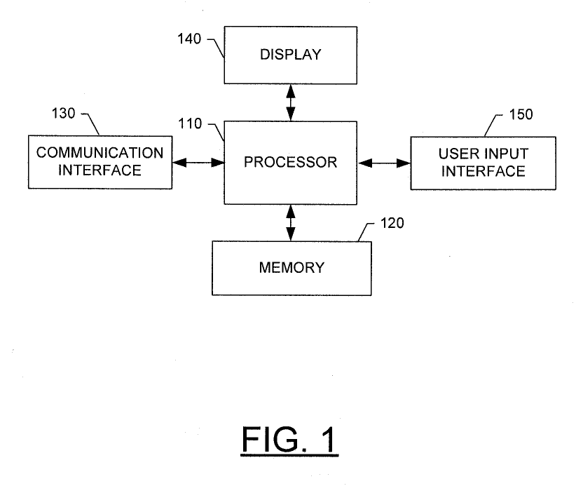

Referring to FIG. 1, a block diagram of an electronic device (e.g., cellular telephone, personal digital assistant (PDA), laptop, etc.) configured to select multiple items using multi-touch in accordance with embodiments of the present invention is shown. The electronic device may include various means for performing one or more functions in accordance with embodiments of the present invention, including those more particularly shown and described herein. It should be understood, however, that one or more of the electronic devices may include alternative means for performing one or more like functions, without departing from the spirit and scope of the present invention. As shown, the electronic device may generally include means, such as a processor 110 for performing or controlling the various functions of the electronic device.

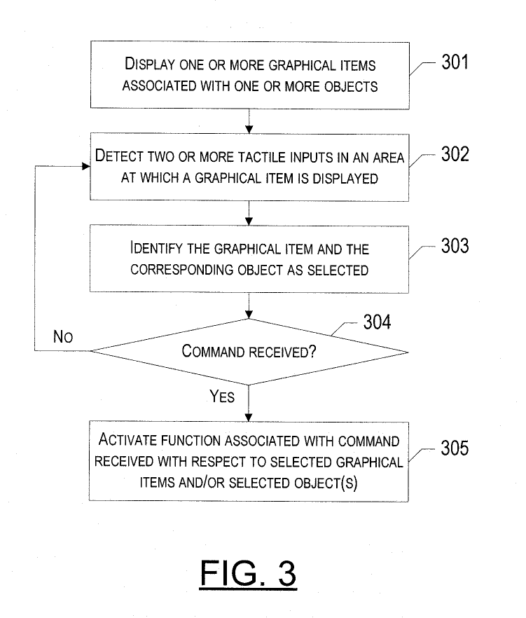

In particular, the processor 110 may be configured to perform the processes discussed in more detail below with regard to FIG. 3. For example, according to one embodiment, the processor 110 may be configured to detect two or more tactile inputs on a touch sensitive input device proximate a location at which each of two or more graphical items is displayed, and to identify the two or more graphical items, as well as the corresponding two or more objects associated with the graphical items, as selected. The processor 110 may be further configured to receive a command, and to cause a function associated with the received command to be activated with respect to the two or more graphical items identified as selected and/or the two or more objects identified as selected.

In one embodiment, the processor 110 may be in communication with or include memory 120, such as volatile and/or non-volatile memory that stores content, data or the like. For example, the memory 120 may store content transmitted from, and/or received by, the electronic device. Also for example, the memory 120 may store software applications, instructions or the like for the processor 110 to perform steps associated with operation of the electronic device in accordance with embodiments of the present invention. In particular, the memory 120 may store software applications, instructions or the like for the processor 110 to perform the operations described above and below with regard to FIG. 3 for selecting multiple items using multi-touch.

For example, according to one embodiment, the memory 120 may store one or more modules for instructing the processor 110 to perform the operations including, for example, a detection module, a selection/de-selection identification module, and a function activation module. In one embodiment, the detection module may be configured to detect the two or more tactile inputs on the touch sensitive input device proximate a location at which each of two or more graphical items is displayed. In response, the selection/de-selection identification module may thereafter be configured to identify the two or more graphical items, as well as the corresponding two or more objects associated with the graphical items, as selected. Finally, the function activation module may be configured to receive a command, and to cause a function associated with the received command to be activated with respect to the two or more graphical items identified as selected and/or the two or more objects identified as selected.

In addition to the memory 120, the processor 110 can also be connected to at least one interface or other means for displaying, transmitting and/or receiving data, content or the like. In this regard, the interface(s) can include at least one communication interface 130 or other means for transmitting and/or receiving data, content or the like, as well as at least one user interface that can include a display 140 and/or a user input interface 150. The user input interface, in turn, can comprise any of a number of devices allowing the electronic device to receive data from a user, such as a keypad, a touchscreen or touch display, a joystick or other input device.

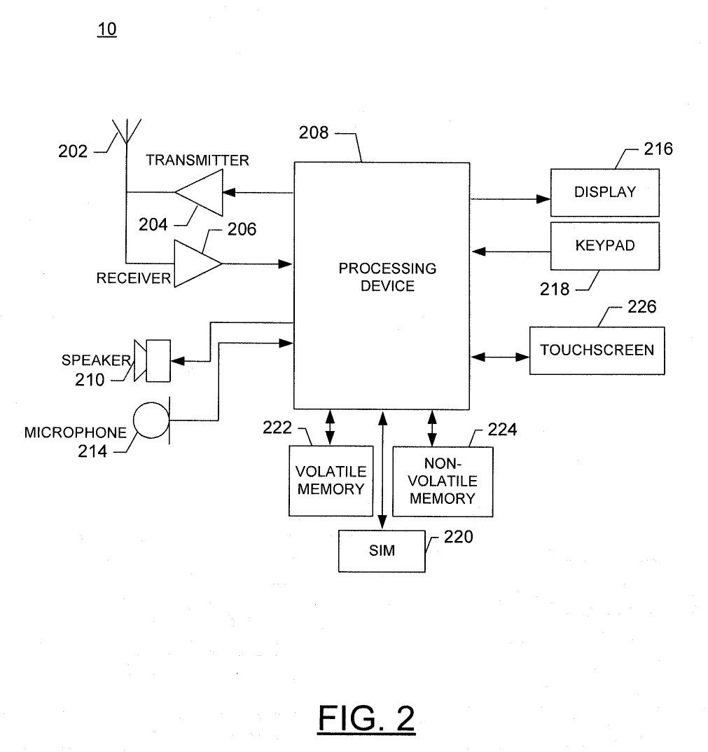

Reference is now made to FIG. 2, which illustrates one specific type of electronic device that may benefit from embodiments of the present invention. As shown, the electronic device may be a mobile station 10, and, in particular, a cellular telephone. It should be understood, however, that the mobile station illustrated and hereinafter described is merely illustrative of one type of electronic device that would benefit from the present invention and, therefore, should not be taken to limit the scope of the present invention. While several embodiments of the mobile station 10 are illustrated and will be hereinafter described for purposes of example, other types of mobile stations, such as personal digital assistants (PDAs), pagers, laptop computers, as well as other types of electronic systems including both mobile, wireless devices and fixed, wireline devices, can readily employ embodiments of the present invention.

The mobile station may include various means for performing one or more functions in accordance with embodiments of the present invention, including those more particularly shown and described herein. It should be understood, however, that the mobile station may include alternative means for performing one or more like functions, without departing from the spirit and scope of the present invention. More particularly, for example, as shown in FIG. 2, in addition to an antenna 202, the mobile station 10 may include a transmitter 204, a receiver 206, and an apparatus that includes means, such as a processor 208, controller, or the like, that provides signals to and receives signals from the transmitter 204 and receiver 206, respectively, and that performs the various other functions described below including, for example, the functions relating to providing an input gesture indicator.

As discussed above with regard to FIG. 2 and in more detail below with regard to FIG. 3, in one embodiment, the processor 208 may be configured to detect two or more tactile inputs on a touch sensitive input device proximate a location at which each of two or more graphical items is displayed, and to identify the two or more graphical items, as well as the corresponding two or more objects associated with the graphical items, as selected. The processor 208 may be further configured to receive a command, and to cause a function associated with the received command to be activated with respect to the two or more graphical items identified as selected and/or the two or more objects identified as selected.

As one of ordinary skill in the art would recognize, the signals provided to and received from the transmitter 204 and receiver 206, respectively, may include signaling information in accordance with the air interface standard of the applicable cellular system and also user speech and/or user generated data. In this regard, the mobile station can be capable of operating with one or more air interface standards, communication protocols, modulation types, and access types. More particularly, the mobile station can be capable of operating in accordance with any of a number of second-generation (2G), 2.5G and/or third-generation (3G) communication protocols or the like. Further, for example, the mobile station can be capable of operating in accordance with any of a number of different wireless networking techniques, including Bluetooth, IEEE 802.11 WLAN (or Wi-Fi®), IEEE 802.16 WiMAX, ultra wideband (UWB), and the like.

It is understood that the processor 208, controller, or other computing device, may include the circuitry required for implementing the video, audio, and logic functions of the mobile station and may be capable of executing application programs for implementing the functionality discussed herein. For example, the processor 208 may be comprised of various means including a digital signal processor device, a microprocessor device, and various analog to digital converters, digital to analog converters, and other support circuits. The control and signal processing functions of the mobile device are allocated between these devices according to their respective capabilities. The processor 208 thus also includes the functionality to convolutionally encode and interleave message and data prior to modulation and transmission. The processor 208 can additionally include the functionality to operate one or more software applications, which may be stored in memory. For example, the processor 208 may be capable of operating a connectivity program, such as a conventional Web browser. The connectivity program may then allow the mobile station to transmit and receive Web content, such as according to HTTP and/or the Wireless Application Protocol (WAP), for example.

The mobile station may also comprise means such as a user interface including, for example, a conventional earphone or speaker 210, a ringer 212, a microphone 214, a display 316, all of which are coupled to the processor 208. The user input interface, which allows the mobile device to receive data, can comprise any of a number of devices allowing the mobile device to receive data, such as a keypad 218, a touch-sensitive input device, such as a touchscreen or touchpad 226, a microphone 214, or other input device. In embodiments including a keypad, the keypad can include the conventional numeric (0-9) and related keys (#, *), and other keys used for operating the mobile station and may include a full set of alphanumeric keys or set of keys that may be activated to provide a full set of alphanumeric keys. Although not shown, the mobile station may include a battery, such as a vibrating battery pack, for powering the various circuits that are required to operate the mobile station, as well as optionally providing mechanical vibration as a detectable output.

The mobile station can also include means, such as memory including, for example, a subscriber identity module (SIM) 220, a removable user identity module (R-UIM) (not shown), or the like, which typically stores information elements related to a mobile subscriber. In addition to the SIM, the mobile device can include other memory. In this regard, the mobile station can include volatile memory 222, as well as other non-volatile memory 224, which can be embedded and/or may be removable. For example, the other non-volatile memory may be embedded or removable multimedia memory cards (MMCs), secure digital (SD) memory cards, Memory Sticks, EEPROM, flash memory, hard disk, or the like. The memory can store any of a number of pieces or amount of information and data used by the mobile device to implement the functions of the mobile station. For example, the memory can store an identifier, such as an international mobile equipment identification (IMEI) code, international mobile subscriber identification (IMSI) code, mobile device integrated services digital network (MSISDN) code, or the like, capable of uniquely identifying the mobile device. The memory can also store content. The memory may, for example, store computer program code for an application and other computer programs.

For example, in one embodiment of the present invention, the memory may store computer program code for selecting multiple items displayed on the touchscreen 226 using multi-touch. In particular, according to one embodiment, the memory may store the detection module, the selection/de-selection identification module, and the function activation module described above with regard to FIG. 2.

The apparatus, method and computer program product of embodiments of the present invention are primarily described in conjunction with mobile communications applications. It should be understood, however, that the apparatus, method and computer program product of embodiments of the present invention can be utilized in conjunction with a variety of other applications, both in the mobile communications industries and outside of the mobile communications industries. For example, the apparatus, method and computer program product of embodiments of the present invention can be utilized in conjunction with wireline and/or wireless network (e.g., Internet) applications.

### Method of Selecting Multiple Items Using Multi-Touch

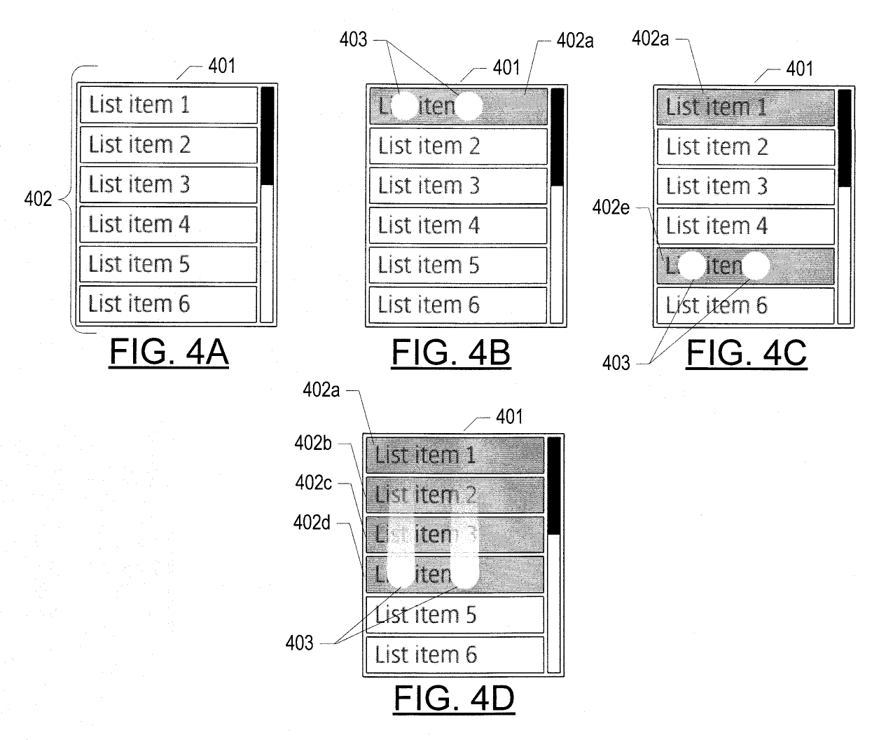

Referring now to FIG. 3-4D, the operations are illustrated that may be taken in order to select multiple items using multi-touch in accordance with embodiments of the present invention. As shown in FIGS. 3 and 4A, the process may begin at Block 301 where the electronic device (e.g., cellular telephone, PDA, laptop, PC, etc.) and, in particular means, such as a processor operating on the electronic device, may cause one or more graphical items 402 associated with one or more objects (e.g., text, audio, video or multimedia files, applications, emails, SMS or MMS messages, etc.) to be displayed on a touch sensitive input device or touchscreen 401. As shown in FIG. 4A, in one embodiment, the graphical items may be displayed in the form of a list. Alternatively, while not shown, the graphical items may be displayed, for example, as thumbnails or icons located at various random locations on the electronic device touchscreen 401. In fact, as one of ordinary skill in the art will recognize, the graphical items may be displayed in any manner or location on the electronic device touchscreen 401 without departing from the spirit and scope of embodiments of the present invention.

At some point thereafter, in order to select a graphical item and its corresponding object, a user may touch the touchscreen using two or more of his or her fingers, or other selection devices, proximate the location at which the graphical item is displayed. As one of ordinary skill in the art will recognize any number of fingers, or other selection devices, greater than one may be used in accordance with embodiments of the present invention. In one embodiment, the multiple touches performed may be substantially simultaneous (i.e., the user may touch the screen using two or more fingers, or other selection devices, at approximately the same time). Alternatively, for example, the user may touch the touchscreen with one finger then, while holding the first finger down, tap the screen with a second finger.

The electronic device (e.g., means, such as a processor and, in one embodiment, the detection module) may, at Block 302, detect the two or more tactile inputs proximate the location at which the graphical item is displayed. The electronic device (e.g., means, such as a processor and, in one embodiment, the detection module) may detect the tactile inputs and determine their location via any number of techniques that are known to those of ordinary skill in the art. For example, the touchscreen may comprise two layers that are held apart by spacers and have an electrical current running there between. When a user touches the touchscreen, the two layers may make contact causing a change in the electrical current at the point of contact. The electronic device may note the change of the electrical current, as well as the coordinates of the point of contact.

Alternatively, wherein the touchscreen uses a capacitive, as opposed to a resistive, system to detect tactile input, the touchscreen may comprise a layer storing electrical charge. When a user touches the touchscreen, some of the charge from that layer is transferred to the user causing the charge on the capacitive layer to decrease. Circuits may be located at each corner of the touchscreen that measure the decrease in charge, such that the exact location of the tactile input can be calculated based on the relative differences in charge measured at each corner. Embodiments of the present invention can employ other types of touchscreens, such as a touchscreen that is configured to enable touch recognition by any of resistive, capacitive, infrared, strain gauge, surface wave, optical imaging, dispersive signal technology, acoustic pulse recognition or other techniques, and to then provide signals indicative of the location of the touch.

The touchscreen interface may be configured to receive an indication of an input in the form of a touch event at the touchscreen. As suggested above, the touch event may be defined as an actual physical contact between a selection device (e.g., a finger, stylus, pen, pencil, or other pointing device) and the touchscreen. Alternatively, a touch event may be defined as bringing the selection device in proximity to the touchscreen (e.g., hovering over a displayed object or approaching an object within a predefined distance).

In response to detecting the two or more tactile inputs, the electronic device (e.g., means, such as a processor and, in one embodiment, the selection/de-selection identification module) may, at Block 303, identify the graphical item and the corresponding object as selected. In particular, according to one embodiment, the electronic device (e.g., means, such as a processor and, in one embodiment, the selection/de-selection identification module) may cause the display of the graphical item to be modified (e.g., changed from a normal state to a “selected” state) in order to indicate that the item and the corresponding object have been selected. For example, the electronic device (e.g., means, such as a processor and, in one embodiment, the selection/de-selection identification module) may cause the graphical item to be highlighted, a tick mark to be generated on one of the corners of the graphical item, the graphical item to change colors, and/or the like.

To illustrate, reference is made to FIG. 4B, which provides an example of an electronic device touchscreen 401, wherein a user has touched the touchscreen 401 using two fingers, or other selection devices, at locations 403 proximate the location at which a graphical item 402a (“List item 1”) has been displayed. In response, the display of the graphical item 402a has been shaded, to indicate that the graphical item 402a and its underlying object have been selected.

In order to identify the underlying object (e.g., the text, audio, video or multimedia file, application, email, SMS or MMS message, etc.) as selected, the electronic device (e.g., means, such as a processor and, in one embodiment, the selection/de-selection identification module) may store a unique identifier associated with the object in a list of selected objects. Alternatively, or in addition, the electronic device (e.g., means, such as a processor and, in one embodiment, the selection/de-selection identification module) may toggle a selected/unselected parameter associated with the object that is, for example, stored in the metadata associated with the object.

At any point after selecting an item and, by extension, an object, the user may input a command designating an action to be taken with respect to the selected item and/or object. The command may correspond to any action or function capable of being performed with respect to any object stored on or accessible by the electronic device including, for example, to edit, delete, move, save, and/or the like.

If it is determined, at Block 304, that a command has not been received, the process may return to Block 302 where another two or more tactile inputs may be detected (e.g., by means, such as a processor and, in one embodiment, the detection module) proximate the location at which another graphical item associated with another object is displayed. This process may continue until the user has selected each of the graphical items, and corresponding objects, in association with which he or she desires to take some action.

As shown in FIG. 4C, in one embodiment, two or more of the graphical items 402a (“List item 1”) and 402e (“List item 5”) selected by the user may be displayed some distance from one another (i.e., not adjacent). In this embodiment, the two or more tactile inputs 403 detected proximate the location at which each of the graphical items 402a and 402e is displayed may comprise isolated tapping. In other words, the user may first tap his or her fingers, or other selection devices, at the first location at which the first graphical item 402a is displayed, lift his or her fingers or other selection devices from the touchscreen 401, and then tap his or her fingers, or other selection devices, at the second location at which the second graphical item 402e is displayed. In one embodiment, the user may leave at least one of his or her fingers, or other selection devices, at the first location while tapping the other finger(s), or other selection device(s), at the second location. For example, the user may touch the touchscreen 401 at the first location using two or more fingers. He or she may then lift one or more of his or her finger(s), while leaving at least one finger at the first location, and then place the lifted finger(s), at the second location.

Alternatively, or in addition, as shown in FIG. 4D, two or more of the graphical items 402a (“List item 1”), 402b (“List item 2”), 402c (“List item 3”) and 402d (“List item 4”) selected by the user may be displayed adjacent to one another. In this embodiment, the two or more tactile inputs 403 detected proximate the location at which each of the graphical items 402a, 402b, 402c and 402d are displayed may be continuous. In other words, the user may drag his or her fingers or other selection devices across the electronic device touchscreen 401 to the locations at which each of the various graphical items 402a, 402b, 402c and 402d is displayed.

According to one embodiment, if at some point the user decides that he or she wishes to de-select or unselect an item that he or she has previously selected, he or she may do so by re-touching the touchscreen proximate the location at which the graphical item is displayed using multiple fingers or other selection devices. In one embodiment, the same number of tactile inputs necessary to select the item and corresponding object may be needed to de-select that item and object. Alternatively, a different number of tactile inputs greater than one may be used.

If the electronic device (e.g., means, such as a processor and, in one embodiment, the detection module) detects the two or more additional tactile inputs proximate a location at which a previously selected graphical item is displayed, the electronic device (e.g., means, such as a processor and, in one embodiment, the selection/de-selection identification module) may restore the graphical item to its original state (i.e., instead of the selected state), remove the unique identifier associated with the object from the list of selected objects, and/or toggle the selected/unselected parameter associated with the object.

Returning to FIG. 3, if, on the other hand, it is determined, at Block 304, that a command has been received, the electronic device (e.g., means, such as a processor and, in one embodiment, the function activation module) may, at Block 305, cause the function associated with the command to be performed with respect to the selected graphical item(s) and/or object(s).

As one of ordinary skill in the art will recognize, depending upon the items and/or objects selected, as well as the command received, the function or action caused to be performed by the electronic device may be in association with the graphical items alone (e.g., moving the graphical items from one location on the electronic device display screen to another location), the objects alone (e.g., saving an email), or to both the items and the objects (e.g., moving the objects from one location in memory to another, resulting in the graphical items being moved; deleting the objects, resulting in the graphical items being removed altogether, etc.)

### CONCLUSION

As described above and as will be appreciated by one skilled in the art, embodiments of the present invention may be configured as an apparatus or method. Accordingly, embodiments of the present invention may be comprised of various means including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus, such as processor 110 discussed above with reference to FIG. 1 or processor 208 discussed above with reference to FIG. 2, to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus (e.g., processor 110 of FIG. 1, or processor 208 of FIG. 2) to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus comprising:
a processor configured to:
detect two or more tactile inputs on a touch sensitive input device proximate a location at which each of two or more graphical items is displayed, said two or more graphical items associated with a corresponding two or more objects;
identify the two or more graphical items and the corresponding two or more objects as selected;
receive a command; and
cause a function associated with the received command to be activated with respect to the two or more graphical items identified as selected, the two or more objects identified as selected, or the two or more graphical items and the two or more objects identified as selected.

2. The apparatus of claim 1, wherein the two or more tactile inputs proximate the location at which at least one of the two or more graphical items is displayed are substantially simultaneous.

3. The apparatus of claim 1, wherein the two or more tactile inputs proximate the location at which a first one of the two or more graphical items is displayed and the two or more tactile inputs proximate the location at which a second one of the two or more graphical items is displayed are continuous.

4. The apparatus of claim 1, wherein in order to identify the two or more graphical items as selected, the processor is further configured to:
cause the display of respective graphical items to be modified from an original state to a selected state.

5. The apparatus of claim 1, wherein in order to identify the two or more objects as selected, the processor is further configured to:
toggle a selected/unselected parameter associated with respective objects.

6. The apparatus of claim 1, wherein in order to identify the two or more objects as selected, the processor is further configured to:
store an identifier associated with respective objects in a list of selected objects.

7. The apparatus of claim 4, wherein the processor is further configured to:
detect two or more additional tactile inputs proximate the location at which at least one of the two or more graphical items identified as selected is displayed; and
identify the at least one of the two or more graphical items and the corresponding object as unselected, in response to detecting the two or more additional tactile inputs, such that, the function is not activated with respect to the graphical item or object identified as unselected.

8. The apparatus of claim 7, wherein, in order to identify the at least one of the two or more graphical items as unselected, the processor is further configured to:
cause the display of the graphical item identified as unselected to be returned to the original state.

9. The apparatus of claim 8, wherein, in order to identify the object as unselected, the processor is further configured to:
toggle a selected/unselected parameter associated with the object identified as unselected.

10. The apparatus of claim 8, wherein, in order to identify the object as unselected, the processor is further configured to:
remove an identifier associated with the object identified as unselected from a list of selected objects.

11. The apparatus of claim 1 further comprising:
a touch display in electronic communication with the processor, said touch display configured to display the two or more graphical items.

12. A method comprising:
detecting two or more tactile inputs on a touch sensitive input device proximate a location at which each of two or more graphical items is displayed, said two or more graphical items associated with a corresponding two or more objects;
identifying the two or more graphical items and the corresponding two or more objects as selected;
receiving a command; and
causing a function associated with the received command to be activated with respect to the two or more graphical items identified as selected, the two or more objects identified as selected, or the two or more graphical items and the two or more objects identified as selected.

13. The method of claim 12, wherein the two or more tactile inputs proximate the location at which at least one of the two or more graphical items is displayed are substantially simultaneous.

14. The method of claim 12, wherein the two or more tactile inputs proximate the location at which a first one of the two or more graphical items is displayed and the two or more tactile inputs proximate the location at which a second one of the two or more graphical items is displayed are continuous.

15. The method of claim 12, wherein identifying the two or more graphical items as selected further comprises:
causing the display of respective graphical items to be modified from an original state to a selected state.

16. The method of claim 12, wherein identifying the two or more objects as selected further comprises:
toggling a selected/unselected parameter associated with respective objects.

17. The method of claim 12, wherein identifying the two or more objects as selected further comprises:
storing an identifier associated with respective objects in a list of selected objects.

18. The method of claim 12 further comprising:
detecting two or more additional tactile inputs proximate the location at which at least one of the two or more graphical items identified as selected is displayed; and
identifying the at least one of the two or more graphical items and the corresponding object as unselected, in response to detecting the two or more additional tactile inputs, such that, the function is not activated with respect to the graphical item or object identified as unselected.

19. A computer program product comprising at least one computer-readable storage medium having computer-readable program code portions stored therein, the computer-readable program code portions comprising:
a first executable portion for detecting two or more tactile inputs on a touch sensitive input device proximate a location at which each of two or more graphical items is displayed, said two or more graphical items associated with a corresponding two or more objects;
a second executable portion for identifying the two or more graphical items and the corresponding two or more objects as selected;
a third executable portion for receiving a command; and
a fourth executable portion for causing a function associated with the received command to be activated with respect to the two or more graphical items identified as selected, the two or more objects identified as selected, or the two or more graphical items and the two or more objects identified as selected.

20. The computer program product of claim 19, wherein the two or more tactile inputs proximate the location at which at least one of the two or more graphical items is displayed are substantially simultaneous.

21. The computer program product of claim 19, wherein the two or more tactile inputs proximate the location at which a first one of the two or more graphical items is displayed and the two or more tactile inputs proximate the location at which a second one of the two or more graphical items is displayed are continuous.

22. The computer program product of claim 19, wherein in order to identify the two or more graphical items as selected, the second executable portion is configured to:
cause the display of respective graphical items to be modified from an original state to a selected state.

23. The computer program product of claim 19, wherein in order to identify the two or more objects as selected, the second executable portion is configured to:
toggle a selected/unselected parameter associated with respective objects.

24. The computer program product of claim 19, wherein in order to identify the two or more objects as selected, the second executable portion is configured to:
store an identifier associated with respective objects in a list of selected objects.

25. The computer program product of claim 19, wherein the computer-readable program code portions further comprise:
a fifth executable portion for detecting two or more additional tactile inputs proximate the location at which at least one of the two or more graphical items identified as selected is displayed; and
a sixth executable portion for identifying the at least one of the two or more graphical items and the corresponding object as unselected, in response to detecting the two or more additional tactile inputs, such that, the function is not activated with respect to the graphical item or object identified as unselected.

26. An apparatus comprising:
means for detecting two or more tactile inputs on a touch sensitive input device proximate a location at which each of two or more graphical items is displayed, said two or more graphical items associated with a corresponding two or more objects;
means for identifying the two or more graphical items and the corresponding two or more objects as selected;
means for receiving a command; and
means for causing a function associated with the received command to be activated with respect to the two or more graphical items identified as selected, the two or more objects identified as selected, or the two or more graphical items and the two or more objects identified as selected.
